(19) United States
(12) Patent Application Publication
(10) Pub. No.: US 2016/0378090 A1
(43) Pub. Date: Dec. 29, 2016

(54) DEVICE MULTI-CONFIGURATOR

(71) Applicant: David Allen Stanley, San Diego, CA (US)

(72) Inventor: David Allen Stanley, San Diego, CA (US)

(73) Assignee: AKTIEBOLAGET SKF, GOTEBORG (SE)

(21) Appl. No.: 14/748,947

(22) Filed: Jun. 24, 2015

(51) Int. Cl. G05B 19/401

(52) U.S. Cl. CPC G05B 19/401

(57) ABSTRACT

Methods, systems, and computer-readable media for configuring a sensor. The method includes obtaining a sensor configuration for a sensor channel of a data acquisition device (DAD) coupled with a sensor, the sensor being configured to measure an operating condition of a machine, and obtaining a machine representation of the machine, the machine representation comprising a point. The point is associated with a point configuration. The method also includes associating the sensor channel with the point, based at least partially on a location of the sensor with respect to the machine and a location of the point in the machine representation. The method further includes automatically determining that the point configuration is out of sync with the sensor configuration associated therewith, and in response to determining that the point configuration is out of sync with the sensor configuration, obtaining a channel configuration or a point configuration update.

### BACKGROUND

Sensors are employed in industrial machines for, among other things, monitoring the operating conditions of the machine. Dozens or even hundreds of sensors may take measurements from a single machine, while a single industrial facility may have dozens or hundreds of machines. Thus, data from potentially thousands of sensors is recorded and used to monitor the machines in a single facility.

Typically, several sensors are connected to a data acquisition device (DAD). The data acquisition device provides multiple channels for receiving the sensor data from individual (or groups) of sensors. A computer executing a configuration application is coupled with the data acquisition device, and potentially several others, and configures the channels, indicating the type of data being received from the sensor, and how the data is received. Another program, sometimes referred to as a point-creation application, is then used to define monitoring and/or protection points (or, more generically, “points”) on the machine. The points may then be associated with the sensors/channels. Finally, a monitoring program may receive data files from either or both of the configuration program and the point-creation program and may record, analyze, etc. the sensor data received via the channel in the data acquisition device.

Moreover, the suite of programs may be configured for use with a particular type of DAD. However, there are many different DADs available in the industry, or even within a particular supplier. In some cases, the programs may be differently configured for the different DADs, which may further complicate configuring the sensor channels thereof.

Furthermore, the monitoring, configuration, and point-creation applications do not typically integrate automatically. Generally, the configuration application creates a “flat” data file providing the configuration parameters of the various channels. The point-creation application then creates points in a representation of a machine, which may also take the form of a flat data file. The monitoring application then imports the flat data files, and a user attempts to associate the correct sensor channels with the correct points. With potentially thousands of sensors, this can be a tedious, time-intensive, and error-prone activity.

### SUMMARY

Embodiments of the disclosure may provide a method for configuring a sensor. The method includes obtaining a sensor configuration for a sensor channel of a data acquisition device (DAD) coupled with a sensor, the sensor being configured to measure an operating condition of a machine, and obtaining a machine representation of the machine, the machine representation comprising a point. The point is associated with a point configuration. The method also includes associating the sensor channel with the point, based at least partially on a location of the sensor with respect to the machine and a location of the point in the machine representation. The method further includes automatically determining that the point configuration is out of sync with the sensor configuration associated therewith, and in response to determining that the point configuration is out of sync with the sensor configuration, obtaining a channel configuration or a point configuration update.

Embodiments of the disclosure may also provide a system including one or more sensors configured to take measurements related to an operation of a machine, a data acquisition device (DAD) coupled with the one or more sensors and configured to receive data therefrom, and a computing system coupled with the data acquisition device and configured to communicate therewith. The computing system includes one or more processors and a memory system that includes one or more non-transitory computer-readable media storing instructions that, when executed by at least one of the one or more processors, cause the computing system to perform operations. The operations include obtaining a sensor configuration for a sensor channel of DAD coupled with at least one of the one or more sensors, and obtaining a machine representation of the machine, the machine representation including a point, with the point being associated with a point configuration. The operations also include associating the sensor channel with the point, based at least partially on a location of the sensor with respect to the machine and a location of the point in the machine representation, and automatically determining that the point configuration is out of sync with the sensor configuration associated therewith. The operations further include, in response to determining that the point configuration is out of sync with the sensor configuration, obtaining a channel configuration or a point configuration update.

Embodiments of the disclosure may further provide a non-transitory computer-readable medium storing instructions that, when executed by at least one processor of a computing system, cause the computing system to perform operations. The operations include obtaining a sensor configuration for a sensor channel of a data acquisition device (DAD) coupled with a sensor, the sensor being configured to measure an operating condition of a machine, and obtaining a machine representation of the machine, the machine representation including a point that is associated with a point configuration. The operations also include associating the sensor channel with the point, based at least partially on a location of the sensor with respect to the machine and a location of the point in the machine representation, and automatically determining that the point configuration is out of sync with the sensor configuration associated therewith. The operations further include, in response to determining that the point configuration is out of sync with the sensor configuration, obtaining a channel configuration or a point configuration update.

It will be appreciated that the foregoing summary is intended merely to introduce certain aspects of the disclosure. These and other aspects are more fully described below. As such, this summary is not intended to be limiting on the claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1A illustrates a condition monitoring system coupled with a machine, according to an embodiment.

FIG. 1B illustrates a flowchart of a method for configuring sensors, according to an embodiment.

FIG. 2 illustrates a display of a sensor channel configuration interface, according to an embodiment.

FIG. 3 illustrates an interface for selecting a machine template, according to an embodiment.

FIG. 4 illustrates a configuration data file including a listing of the sensor channels and their associated configurations, according to an embodiment.

FIG. 5 illustrates an interface for modifying sensor channel configurations received in the configuration data file, according to an embodiment.

FIG. 6 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

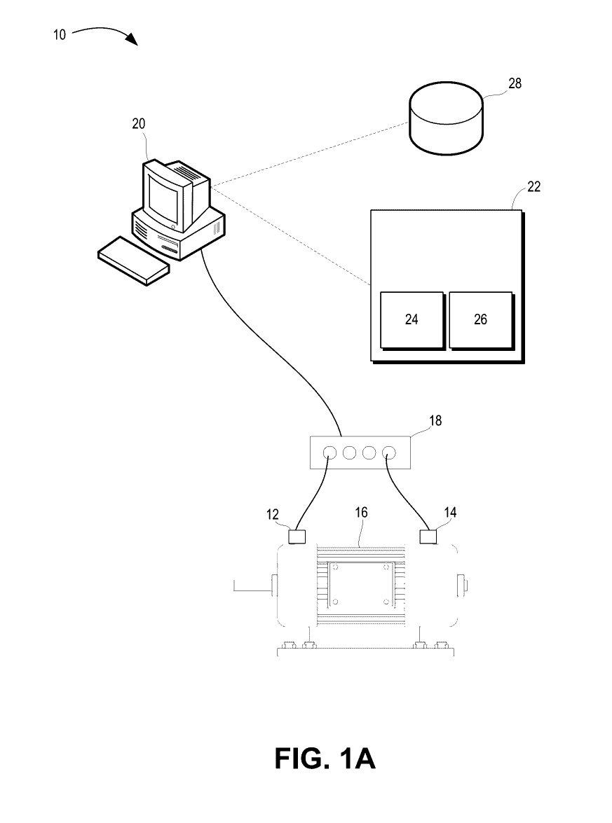

FIG. 1A illustrates a conceptual, schematic view of a condition monitoring system 10, according to an embodiment. The condition monitoring system 10 may include one or more sensors (two shown: 12, 14), which may be coupled with a machine 16 and configured to take measurements representing one or more physical properties thereof. A variety of such sensors are known, and any type of sensor, and any number of sensors, may be employed within the scope of the present disclosure. Similarly, the condition monitoring system 10 may be configured for use with any type of machine 16, and potentially several machines at once.

The sensors 12, 14 may be coupled with a data acquisition device 18, which in turn may be coupled with a computer (or multiple computers) 20. The data acquisition device 18 may include several channels, e.g., one for each of the sensors 12, 14, although more or fewer channels than the number of sensors 12, 14 may be employed in some embodiments. The channels of the data acquisition device 18 may receive electrical signals from the sensors 12, 14, which may be converted into useful information by the data acquisition device 18. Although one data acquisition device 18 is shown, it will be appreciated that several may be provided within a single condition monitoring system 10.

The computer 20 may be configured to execute a multi-configurator application 22. The multi-configurator application 22 may include plugins or other applications such as a configuration manager 24 and a point-creation manager 26. The configuration manager 24 and the point-creation manager 26 may be configured to interact seamlessly (from the perspective of a user of the computer 20) and may pass information back-and-forth to facilitate configuration of the sensors 12, 14 with the computer 20.

Further, the computer 20 may be configured to receive input from a user, e.g., as part of the execution of the multi-configurator application 22. The multi-configurator application 22 may also interface with a database 28, which may contain information about sensor channels, such as the configurations, locations, etc., thereof and/or may contain machine templates, as will be described in greater detail below.

The provision of such plugins/applications as part of the multi-configurator application 22 may avoid a user manually importing and exporting data files, creating points and/or configuring channels multiple times, redundantly, and/or manually entering data collected in one context into another application. In other embodiments, however, manual data entry may be enabled, such as for updating. Further, in some instances, a shell program may be provided which may allow the configuration manager 24, the point-creation manager 26, or both to be executed separately from the “umbrella” multi-configurator application 22, e.g., for diagnostic, training, or other purposes.

Executing the multi-configurator application 22 may cause the computer 20 to perform operations within the context of the condition monitoring system 10. FIG. 1B illustrates a flowchart of a method 100 for collecting sensor data, which may provide an example of such operations, according to an embodiment. In particular, the method 100 may facilitate configuration of the sensors 12, 14 coupled with the machine 16 and in communication with the data acquisition device 18. The method 100 may also facilitate construction of a digital machine instance or representation. Such a machine representation may include data representing the sensors 12, 14 and the points of the machine 16 where the sensors 12, 14 are located and/or where protection is to be established in the machine 16.

The configuration manager 24 may interface with the data acquisition device 18 and define configurations for the sensors 12, 14 coupled therewith. The point-creation manager 26 may facilitate importing points and configurations of sensors thereof from a configuration file, which may be stored in the database 28. Furthermore, the point-creation manager 26 may be configured to retrieve and apply machine templates. Such configurations may include data such as the sensor location, the type of data received, the form in which the data is received, conversion factors, operations, etc.

In the illustrated embodiment, the method 100 includes determining whether the configurations will be entered manually or imported through a configuration file, such as at 101. This determination may be based on a selection by a user, or may be automatically determined, e.g., based on the presence or absence of such a configuration file. In some embodiments, configurations may be partially received from a configuration file and partially entered manually.

If the determination at 101 is “NO” (i.e., manual input to occur), the method 100 may proceed to obtaining sensor channel configurations via user input, e.g., manually through the configuration manager 24. If the determination at 101 is “YES” (i.e., a configuration file is to be used), the method 100 may proceed to obtaining configurations for a plurality of sensor channels representing sensor measurements taken at a plurality of points of a machine, as at 102, e.g., by operation of the computer 20 executing the configuration manager 24. As mentioned above, the sensor channels may be the electrical pathway for measurement data signals received from the sensors 12, 14, and the configuration manager 24 may be employed to allow for the signals from the sensors 12, 14 via the channels to be interpreted into useful information.

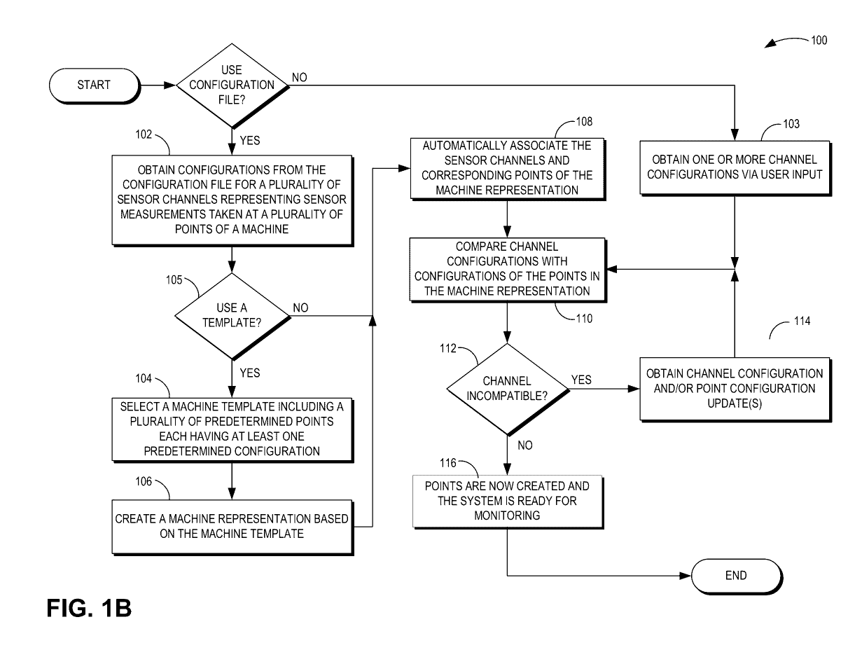

FIG. 2 illustrates an interface 200 for configuring a sensor channel, e.g., manually, and/or for allowing a view of automatically configured sensor channels (such as from a configuration data file), according to an embodiment. As shown, the (e.g., analog) channels may be configured in a first window 202. The configurations may include various parameters of the sensor, and may specify safe operating conditions by allowing a user to set alarm levels for the sensor. The details of the configuration may be adjusted in a second window 204, which may provide one or more menus or boxes allowing a user to input values for the sensor being configured. The configurations for the sensor channels may thus be entered and may be saved to a data file for later use, which will be described below according to an example.

Referring again to FIG. 1B, the method 100 may include determining whether to use a machine template, as at 105. This may be based on user input, but, in some cases, may also take into consideration whether or not suitable machine templates are available or not. For example, if the execution of the method 100 is directed toward updating a pre-existing machine representation or configuration of sensors, the determination at 105 may be “NO.”

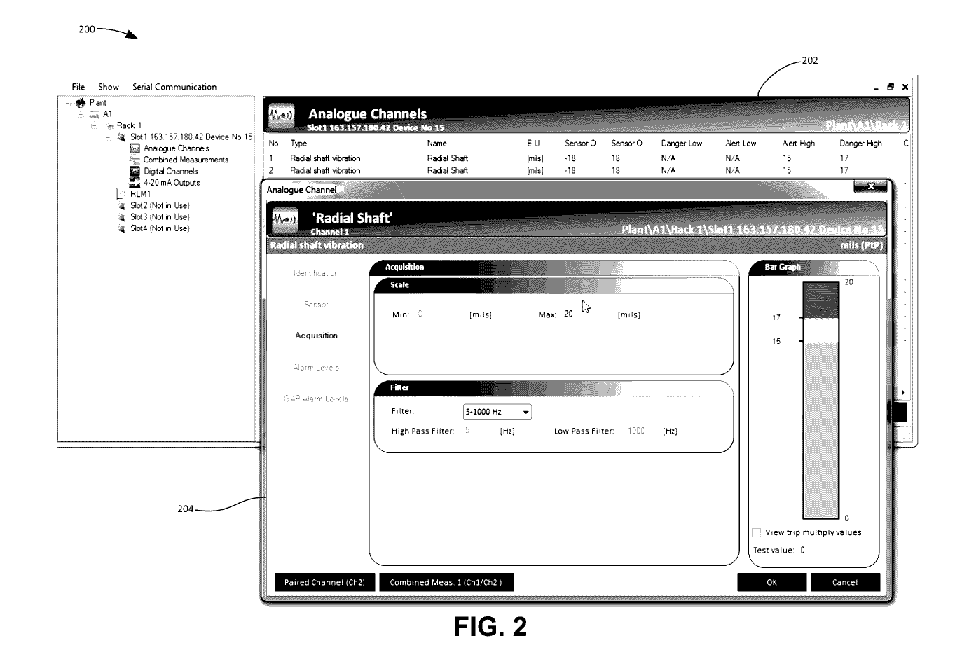

If the determination is “YES” at 105, the method 100 may proceed to selecting a machine template, e.g., from a library thereof, as at 104. The selection may be based on user input, e.g., received through an interface. FIG. 3 illustrates an example of an interface 300 for receiving user input to select a machine template. The machine template may be identified by name, location, or both. Further, the interface may include functionality for creating a new machine template using the configuration data file previously created.

The machine template may include a plurality of predetermined points each having at least one predetermined configuration. For example, a machine template may be provided by a data file. The data file may include a listing of the predetermined points of the machine. The predetermined points may correspond to locations on a machine where sensors have been or are commonly employed. In some embodiments, the template may also specify a predetermined configuration for sensors located at the various points.

Again referring to FIG. 1B, the method 100 may also include creating a machine representation based on the machine template, as at 106. The machine representation may be instantiated by creating a data file, which may be populated at least partially by the data included in the machine template that was selected at 104.

Next, or, if the determination at 105 was “NO”, then instead of selecting a machine template at 104 and creating the machine representation at 106, the method 100 may further include automatically associating the sensor channels and the corresponding points of the machine representation, as at 108. As the term is used herein, “automatically” generally means without user prompting or guidance (or, at least without the necessity of user prompting), the action occurs by operation of the computer 20. This association may be based on location of the sensors 12, 14 with respect to the machine 16 and/or one or more other factors such as sensor type.

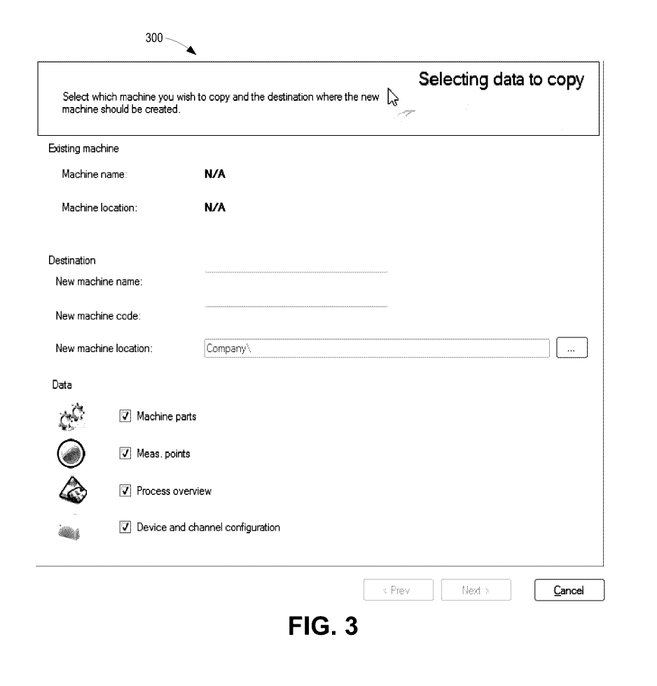

In an embodiment, the data file created by the configuration manager 24 may list configurations and points associated with the machine sensor channels. FIG. 4 illustrates an example of such a data file, which lists sensor channels, and provides information and settings as to the configuration of the sensor coupled with each channel.

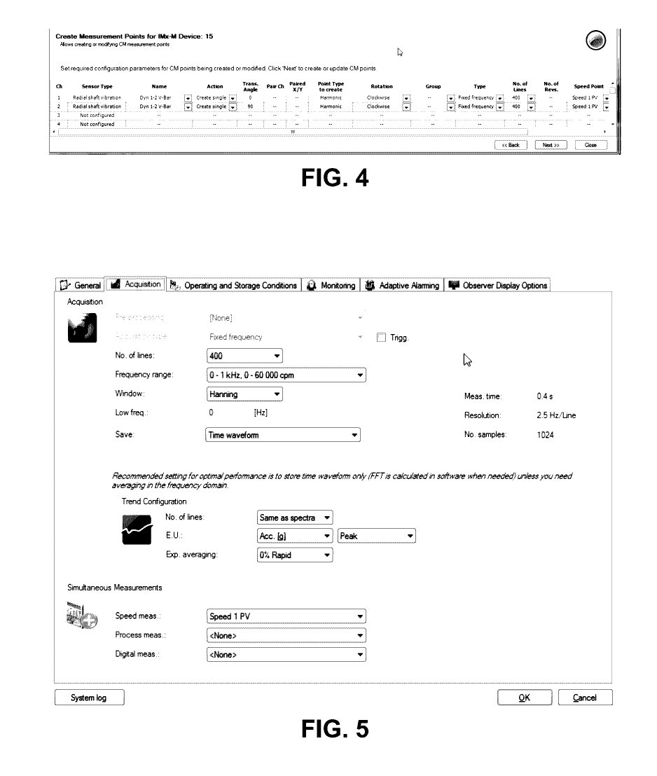

The machine representation may include a listing of points and configurations, based on the selected machine template (if used) and/or user input. Thus, at 108, the sensor channels may be associated with the points of the machine representation to automatically complete the building of the machine representation. The process of setting up the sensor channels and associating the sensor channels with the points of the machine representation may be flexible, and may allow for user intervention throughout. Accordingly, as shown in FIG. 5, an interface may be provided to the user, allowing the user to select a point or channel, check the configuration associated therewith, and make any necessary adjustments.

In some situations, it may be possible for sensor configurations to be out of sync with the configurations of the associated points of the machine representation. Accordingly, the method 100 may include comparing the channel configurations with the configurations of the points in the machine representation, as at 110. Such comparisons may ensure that the sensor data is in line with expected sensor data, e.g., in terms of what physical characteristic is being measured (e.g., vibration, acceleration, speed, temperature, pressure, etc.), how the measurements are delivered (e.g., voltage ranges, etc.), and the characteristics of the measuring (e.g., sampling frequency). To accomplish this, the method 100 may include the program communicating directly with the sensing device and/or the data acquisition device, so as to determine the configuration of the sensor 12, 14. For example, the computer 20 may directly interrogate the data acquisition device 18 to determine the channel properties/configurations thereof (i.e., the “DAD configurations”), and then compare the results with the sensor channel configurations as they exist in the multi-configurator application 22.

The method 100 may then determine that one or more channels are incompatible or “out of sync” with the point configurations of the machine representations. The channels may be out of sync with the configuration of the machine representation when the configurations thereof do not match, which may be determined based on the comparison at 110. This may yield a “YES” determination at 112. In such case, the method 100 may allow for corrective action to occur, such as by obtaining channel configuration and/or point configuration update(s), as at 114. In an embodiment, such corrective action may occur by displaying or highlighting, visually, points on the machine where such inconsistencies occur and soliciting a user input to address the inconsistency (e.g., using the interface of FIG. 5). In other embodiments, the corrective action may include reconfiguring the point of the machine representation and/or the sensor channel, e.g., based on the results of the aforementioned interrogation of the data acquisition device 18. The corrective action might also include selecting a different sensor channel (such as when two points appear to be swapped), or otherwise automatically addressing the incompatibilities. Once such incompatibilities are addressed, the method 100 may return to comparing the channel and point configurations at 110, until the machine representation and sensor channels are fully configured or the process is otherwise terminated. At this point, e.g., 116 in FIG. 1B, the points may be created and the system 10 may be ready for monitoring, e.g., by collecting data from the sensors 12, 14 via the channels of the data acquisition device 18.

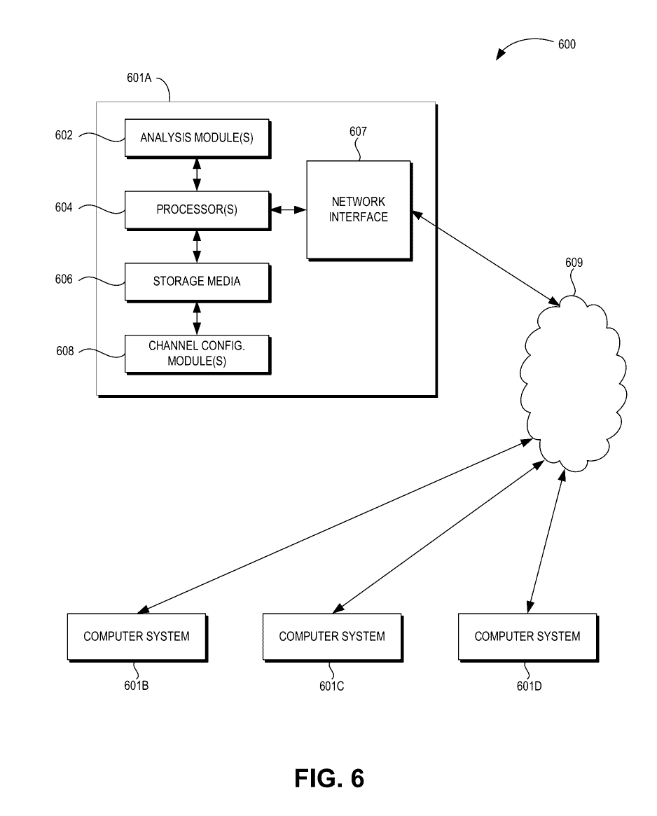

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURRY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more channel configuration module(s) 608. In the example of computing system 600, computer system 601A includes the channel configuration module 608. In some embodiments, a single channel configuration module may be used to perform some aspects of one or more embodiments of the methods disclosed herein. In alternate embodiments, a plurality of channel configuration modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Geologic interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

What is claimed is:

1. A method for configuring a sensor, comprising:
obtaining a sensor configuration for a sensor channel of a data acquisition device (DAD) coupled with a sensor, the sensor being configured to measure an operating condition of a machine;
obtaining a machine representation of the machine, the machine representation comprising a point, wherein the point is associated with a point configuration;
associating the sensor channel with the point, based at least partially on a location of the sensor with respect to the machine and a location of the point in the machine representation;
automatically determining that the point configuration is out of sync with the sensor configuration associated therewith; and
in response to determining that the point configuration is out of sync with the sensor configuration, obtaining a channel configuration or a point configuration update.

2. The method of claim 1, wherein automatically determining that the point configuration is out of sync with the sensor configuration comprises:
interrogating the DAD for a DAD sensor configuration; and
comparing the DAD sensor configuration with the point configuration.

3. The method of claim 1, further comprising:
determining that a configuration file is not to be used; and
in response, obtaining the sensor configuration from user input.

4. The method of claim 1, further comprising:
determining that a configuration file comprising a plurality of sensor configurations, including the sensor configuration, for a plurality sensors is to be used; and
automatically obtaining the plurality of sensor configurations from the configuration file.

5. The method of claim 1, further comprising:
determining that a machine template is to be used, wherein the machine template comprises a plurality of points associated with predetermined point configurations;
selecting the machine template from among several machine templates stored in a database; and
creating a machine representation based on the machine template.

6. The method of claim 1, further comprising:
determining that the sensor configuration has changed; and
in response, obtaining an update to the sensor configuration, an update to the point configuration, or both.

7. A system, comprising:
one or more sensors configured to take measurements related to an operation of a machine;
a data acquisition device (DAD) coupled with the one or more sensors and configured to receive data therefrom;
a computing system coupled with the data acquisition device and configured to communicate therewith, the computing system comprising one or more processors and a memory system comprising one or more non-transitory computer-readable media storing instructions that, when executed by at least one of the one or more processors, cause the computing system to perform operations, the operations comprising:
obtaining a sensor configuration for a sensor channel of DAD coupled with at least one of the one or more sensors;
obtaining a machine representation of the machine, the machine representation comprising a point, wherein the point is associated with a point configuration;
associating the sensor channel with the point, based at least partially on a location of the sensor with respect to the machine and a location of the point in the machine representation;
automatically determining that the point configuration is out of sync with the sensor configuration associated therewith; and
in response to determining that the point configuration is out of sync with the sensor configuration, obtaining a channel configuration or a point configuration update.

8. The system of claim 7, wherein automatically determining that the point configuration is out of sync with the sensor configuration comprises:
interrogating the DAD for a DAD sensor configuration; and
comparing the DAD sensor configuration with the point configuration.

9. The system of claim 7, wherein the operations further comprise:
determining that a configuration file is not to be used; and
in response, obtaining the sensor configuration from user input.

10. The system of claim 7, wherein the operations further comprise:
determining that a configuration file comprising a plurality of sensor configurations, including the sensor configuration, for a plurality sensors including the one or more sensors, is to be used; and
automatically obtaining the plurality of sensor configurations from the configuration file.

11. The system of claim 7, wherein the operations further comprise:
determining that a machine template is to be used, wherein the machine template comprises a plurality of points associated with predetermined point configurations;
selecting the machine template from among several machine templates stored in a database; and
creating a machine representation based on the machine template.

12. The system of claim 7, wherein the operations further comprise:
determining that the sensor configuration has changed; and
in response, obtaining an update to the sensor configuration, an update to the point configuration, or both.

13. A non-transitory computer-readable medium storing instructions that, when executed by at least one processor of a computing system, cause the computing system to perform operations, the operations comprising:
obtaining a sensor configuration for a sensor channel of a data acquisition device (DAD) coupled with a sensor, the sensor being configured to measure an operating condition of a machine;
obtaining a machine representation of the machine, the machine representation comprising a point, wherein the point is associated with a point configuration;
associating the sensor channel with the point, based at least partially on a location of the sensor with respect to the machine and a location of the point in the machine representation;
automatically determining that the point configuration is out of sync with the sensor configuration associated therewith; and
in response to determining that the point configuration is out of sync with the sensor configuration, obtaining a channel configuration or a point configuration update.

14. The medium of claim 13, wherein automatically determining that the point configuration is out of sync with the sensor configuration comprises:
interrogating the DAD for a DAD sensor configuration; and
comparing the DAD sensor configuration with the point configuration.

15. The medium of claim 13, wherein the operations further comprise:
determining that a configuration file is not to be used; and
in response, obtaining the sensor configuration from user input.

16. The medium of claim 13, wherein the operations further comprise:
determining that a configuration file comprising a plurality of sensor configurations, including the sensor configuration, for a plurality sensors is to be used; and
automatically obtaining the plurality of sensor configurations from the configuration file.

17. The medium of claim 13, wherein the operations further comprise:
determining that a machine template is to be used, wherein the machine template comprises a plurality of points associated with predetermined point configurations;
selecting the machine template from among several machine templates stored in a database; and
creating a machine representation based on the machine template.

18. The medium of claim 13, wherein the operations further comprise:
determining that the sensor configuration has changed; and
in response, obtaining an update to the sensor configuration, an update to the point configuration, or both.
